(19) United States
(12) Patent Application Publication
(10) Pub. No.: US 2002/0138656 A1
(43) Pub. Date: Sep. 26, 2002

(54) System for and method of providing interfaces to existing computer applications

(76) Inventor: Neil Hickey, Golden, CO (US)

Correspondence Address: Sam Pasternack, Choate, Hall & Stewart, 53 State Street, Exchange Place, Boston, MA, 02109, US

(21) Appl. No.: 09/815,806

(22) Filed: Mar. 23, 2001

(51) Int. Cl. G06F 15/16; G06F 9/00; G06F 9/46

(52) U.S. Cl. 709/250; 709/328

(57) ABSTRACT

A system for and method of providing interfaces between client devices and existing software applications. This may include interfacing existing software applications via wired and wireless intranets or the Internet to client devices that may include voice-enabled client devices. The interface could also be in two different languages. The embodiments described below share the ability to monitor, reinterpret, and reformat data streams by means of a computer operating trainable user interface translator applications.

### FIELD OF THE INVENTION

The present invention relates generally to providing interfaces to existing applications. More specifically, by monitoring, reinterpreting and reformatting data streams the invention allows interfacing between existing applications and wired and wireless Internets, voice-enabled devices, and users who speak languages other than those in which the existing applications are written.

### BACKGROUND OF THE INVENTION

There are thousands of existing text-based applications designed for terminals like the IBM 3270 and the DEC VT200. Companies using these applications benefit from the usefulness of these applications but have a need to make the associated data and logic accessible remotely, such as via the Internet or via wireless networks. Typically, companies faced with inaccessible applications rewrite the application. However, this approach is often not cost effective because of the associated high development cost. Further, when organizations rewrite applications, much of the business logic inherent to the original application is lost, reducing the functionality of the newly created application. In client-based applications, this situation can lead to operational efficiencies, decreased customer satisfaction, and compromised security.

Due to the widespread use of text-based applications combined with a demand for remote operations, the market for software products that make these applications accessible remotely has grown into the billions of dollars per year. As increasing numbers of business functions migrate to the Internet and wireless applications, existing software applications will be expected to perform in these arenas.

Text-based applications that are not remotely accessible by users can cause a number of inefficiencies. For example, in the case of a business utilizing an inventory program, it is most efficient for the business if the program is accessible from the warehouse floor. Furthermore, the program best serves the business if the functionality and data associated with the program can be accessed on a wireless device that can then be carried about the warehouse floor to different locations. However, current text-based applications are not enabled for wireless devices or for the Internet, leading to relatively inefficient business operations. What is needed is a way to improve the efficiency of a business.

The ever-quickening pace of change in the arena of remote computer access leaves many business applications obsolete, or at least outdated, in a short amount of time. The Internet, PDAs, cell phones, etc., are all recent innovations to which existing applications must adapt in order to remain useful to business customers. Outdated applications can result in customer loss because of inaccessibility, decreased performance, and poor functionality. What is needed is a way to better service customers who need information residing on inaccessible computer systems.

Many existing applications contain data that is needed by users operating computers remotely. Further, remote users often have data that must be stored within an application. Currently, most existing applications provide no means for remote users to interact with the application, reducing the usefulness of the application, increasing inefficiencies, and raising the costs associated with doing business. What is needed is a way to enable users to remotely enter as well as remotely access data in an existing application via the Internet or a wireless device.

Increasing the functionality of existing applications in addition to making them remotely accessible can greatly increase the efficiency of business operations, and thus increase cost savings. For example, reformatting display screens so that an Internet business customer is presented with different functionality than business personnel can lead to increased security. However, enhancing the functionality of existing applications is difficult without recoding the entire application, which is costly and time-consuming. What is needed is a way to enable a business to rapidly provide access to data in an existing application via the Internet with additional features like security.

Businesses must often utilize numerous computer systems to service all aspects of their operations. Because different people may have created these systems at different times, they often lack a uniform interface with the user. Non-uniform interfaces can lead to a number of operational inefficiencies, such as increased training time for users, compromised corporate identity, and confusing functionality. What is needed is a way to provide a uniform interface to data residing in multiple computer systems.

The widespread use of voice-enabled devices like cell phones, which often lack a traditional display and keyboard, requires improved means of interfacing with existing applications. To facilitate access to the data and business logic of existing applications for users employing such voice-enabled devices, the controlling software of these devices must convert existing data to voice prompts and reports, as well as accept spoken information as input to the applications. For example, a shipping company may want to allow customers to check the shipping status of a package from the company's scheduling application via a cell phone. By offering this feature, the shipping company may dramatically increase its client base. To make the interface of the existing applications best suited to a voice interface, the controlling software must select data from the traditional display for vocalization and prompt users for input information in small, comprehensible increments. What is needed is a way to enable a user to access an existing application via a voice interface.

As software becomes available that enables users to access an existing application via a voice interface, tailoring the presentation of information from the existing application to the user becomes an important consideration. The interface of the existing application must be suited to a voice interface in order to be comprehensible to the user. For example, a shipping company would not want a voice interface to overwhelm the user with all of the information that is offered on its traditional display (e.g., company address, user's contact information, company slogan, etc.) because much of this information is extraneous and difficult to process during a voice interface session. Rather, the shipping company would want to select and transform the information contained in its traditional display to information that is relevant to the user's request. What is needed is a way to redesign the interface to an existing application so that it is suited to a voice interface.

With the increasing globalization of the world, language translation is increasingly becoming an essential requirement of conducting business. There are thousands of existing applications that must accommodate speakers and writers of languages different from those used in the original applications. Typically, companies faced with applications inaccessible to those who speak and write other languages must rewrite the application in the target language or resort to tools that enable limited word-for-word translations. Unfortunately, rewriting applications is generally not cost effective because of the associated high development costs, and word-for-word translation does not account for cultural conventions in the application interface. Further, when organizations rewrite applications for the sake of accommodating different languages, much of the business logic inherent to the original application may be lost, thus reducing the functionality of the newly created application. Existing software translation applications typically perform translation on a word for word basis, which is limited in its functionality due to its reliance on predefined source files and its tendency to distort the interface of the existing application. What is needed is a way to provide an effective interface to an existing application in a different language without translating the content word for word.

In order to provide an effective translation interface of an existing application to a different language, culture-specific norms must be considered and accommodated. For example, in many countries the calendar date is formatted as DD-MM-YY, whereas the calendar date in the U.S. is formatted as MM-DD-YY. Other examples of culture-specific conventions include the direction text is written on a page, colors used for illustration, and table formatting. Careful attention to these culture-specific conventions may determine the ultimate success of a translation tool. Cross-cultural norms are often at odds with each other and can be a particularly sensitive topic. For example, a user of an existing application in one country registering at a hospital may expect to be asked to provide a guarantor, whereas a user in another country may find a request for a guarantor insulting. Current translation software tools are typically unable to provide flexibility within the business logic executed in an existing application, leading to ineffective tools and unsatisfied customers. What is needed is a way to adjust the business logic of an existing application to make it suited to another culture.

### SUMMARY OF THE INVENTION

The present invention is a system for and method of providing interfaces between client devices and existing software applications. This can include interfacing existing software applications via wired and wireless intranets or the Internet to client devices that may include voice-enabled client devices. The interface could also be in two different languages. The embodiments described below share the ability to monitor, reinterpret, and reformat data streams by means of a computer operating a software training application. The techniques employed in the current invention build upon “trainable user interface translator” technology (referred to below as “TeleShaper” technology) as described in U.S. Pat. Nos. 5,627,977 and 5,889,516, which are assigned to the assignee of the present application and which are hereby incorporated by reference in their entirety into the present application.

In a first embodiment, the invention is a trainable system for providing an interface to an existing software application via a wired or wireless network, comprising a first computer operating a trainable user interface translator application and adapted to store a shaper rule set, a Web server, at least one client device, a format data storage device, a training terminal, one or more local or remote host computers operating an existing host applications thereby generating data streams which may be monitored by the first computer, and a wired or wireless network providing electrical connection between the first computer and the web server, the first computer and the training terminal, the first computer and the one or more host computers, and the web server and at least one client device. The first computer transmits data received from the at least one client device via the web server to the one or more host computers and, according to the shaper rule set established during a training session, monitors and reinterprets the data streams present in the existing host applications into updated forms for transmission to the web server, which reformats the updated forms using format data stored in the format data storage device for transmission to the at least one client device.

In another aspect, the invention is a method of defining the representation of data on the client device, training the trainable system to operate the existing host applications to insert data to and extract data from one or more host computers, and using the trained system to provide an interface via wired and wireless networks. Employing the apparatus described in the previous paragraph, the method comprises the steps of defining a transaction from the training terminal, selecting sample training data sets, choosing a data set from the training data sets, defining input and result screens, creating an actual screen representation in accordance with the requirements of the host applications, creating a list of input and output variables, starting the training mode and selecting a starting page from a client device, filling in page data from the client device, transmitting the page data to the first computer, exercising the host applications to obtain needed responses to the page data while storing the sequence of steps for exercising the one or more host applications as a rule set, instructing the first computer to send a response page to the client device while storing additional elements in the rule set, completing a form contained in the response page and sending the completed form to the training terminal, determining if the trainable system is fully trained to complete a business process, and if not, reverting to the step of exercising the one or more host applications, and determining if there are additional selected sample training data sets to process, and if so, reverting to the choosing a data set step. The training session data sets should include normal operating data and exception data to allow the trained system to programmatically correct errors and exceptions within existing applications.

In a second embodiment, the invention is a trainable system for providing a voice interface to an existing software application, comprising a first computer operating a trainable user interface translator application and adapted to store a shaper rule set, a text-to-speech and speech-to-text interface computer, at least one voice-enabled client device, a vocabulary data storage device, a training terminal, one or more local or remote host computers operating existing host applications thereby generating data streams which may be monitored by the first computer. The first computer transmits data received from the at least one voice-enabled client device via the text-to-speech and speech-to-text interface computer to the one or more host computers and, according to the shaper rule set established during a training session, monitors and reinterprets the data streams present in the existing host applications into updated forms for transmission to the text-to-speech and speech-to-text interface computer, which reformats the updated forms using vocabulary data stored in the vocabulary data storage device for transmission to the at least one voice-enabled client device. The system components may be directly connected, or connected via a network.

In another aspect, the invention is a method of defining the representation of data on the voice-enabled client device, training the trainable system to operate the existing host applications to insert data to and extract data from one or more host computers, and using the trained system to provide a voice interface to the existing host applications. Employing the apparatus described in the previous paragraph, the method comprises the steps of defining a transaction from the training terminal, selecting sample training data sets, choosing a data set from the training data sets, defining input and output portions, creating a required spoken representation of prompts, valid responses and outputs in accordance with the requirements of the host applications, creating a list of input and output variables and associated vocabulary lists, starting the training mode and requesting a starting prompt from the voice-enabled client device, replying to the prompt via the voice-enabled client device, transmitting the reply to the first computer, exercising the host applications from the training terminal to obtain needed responses to the reply data while storing the sequence of steps for exercising the host applications in the rule set, instructing the first computer to send a response to the voice-enabled client device via the text-to-speech and speech-to-text interface computer which formats the response combining vocabulary data stored on a vocabulary data storage device with prompt and variable data received from the first computer while storing additional elements in the rule set, speaking the sample data via the voice-enabled client device and sending the voice data to the training terminal, determining if the trainable system is fully trained to complete a business process, and if not, reverting to the step of exercising the one or more host applications, and determining if there are additional selected sample training data sets to process and if so, reverting to the choosing a data set step.

In a third embodiment, the invention is a trainable system for providing an interface to an existing software application via in a different language, comprising a first computer operating a trainable user interface translator application and adapted to store a shaper rule set, an interface computer, at least one client device, a format data storage device, a training terminal, and one or more local or remote host computers operating an existing host application thereby generating data streams which may be monitored by the first computer. The first computer transmits data received from the at least one client device via the interface computer to the one or more host computers and, according to the shaper rule set established during a training session, monitors and reinterprets the data streams present in the existing host applications into updated forms for transmission to the interface computer, which reformats the updated forms using target language data stored in the format data storage device for transmission to the at least one client device.

In another aspect, the invention is a method of defining the representation of data on the client device, training the trainable system to operate the existing host applications to insert data to and extract data from one or more host computers, and using the trained system to provide an interface to an existing application in another language. Employing the apparatus described in the previous paragraph, the method comprises the steps of defining a transaction from the training terminal and storing transaction data elements in the rule set, selecting sample training data sets in a source language and a target language, choosing a data set from the training data sets, defining input and output screens in accordance with the requirements of the host applications, creating a representation of input and output screens in the target language, creating a list of input and output variables associated with each input and output screens, creating an output data and input data translation vocabulary, starting the training mode and requesting a starting page from the client device, completing with page data a form returned from the interface computer in response to the request for the starting page, transmitting the page data to the first computer, exercising the host applications to obtain needed responses to the page data while storing the sequence of steps for exercising the one or more host applications in the rule set, instructing the first computer to send a response page to the client device while storing additional elements in the rule set, completing a form contained in the response page and sending the completed form to the training terminal, determining if the trainable system is fully trained to complete a business process, and if not, reverting to the step of exercising the one or more host applications, and determining if there are additional selected sample training data sets to process, and if so, reverting to the choosing a data set step. The training session data sets should include normal operating data and exception data to allow the trained system to programmatically correct errors and exceptions within existing applications.

Each of the embodiments described above have the ability to provide access for users who require information from existing applications but are unable to access them. The present invention can be quickly implemented with a minimal amount of training. It obviates the need to recode existing applications in order to gain increased functionality, and can accommodate changes in the existing host applications. It can utilize the existing error checking and error handling functionality in the existing source applications. In addition, it allows the use of old access methods while accommodating updated access methods, thereby extending the life of existing computer assets.

### BRIEF DESCRIPTION OF THE DRAWINGS

FIG. 1 is a schematic diagram of a first embodiment of the present invention providing an interface to an existing computer application via wired and wireless Internets.

FIG. 2 is a flow diagram illustrating a method of defining the representation of data on a client device and training the TeleShaper system to operate an existing application to insert data to and extract data from an existing system via the Internet.

FIG. 3 is a flow diagram illustrating a method of using the present invention to operate an existing computer application via the Internet.

FIG. 4 is a schematic diagram of a second embodiment of the present invention providing a voice interface to an existing computer program.

FIG. 5 is a flow diagram illustrating a method of defining the representation of data on a voice-enabled client device and training the TeleShaper system to operate an existing application to insert data to and extract data from an existing system.

FIG. 6 is a flow diagram of a method of using the TeleShaper system to insert data to and extract data from an existing software application via voice.

FIG. 7 is a schematic diagram of a third embodiment of the present invention providing an interface to an existing computer program in a different language.

FIG. 8 is a flow diagram illustrating a method of defining the representation of data on a client device and training the TeleShaper system to operate an existing software application to insert and extract data from an existing system in another language.

FIG. 9 is a flow diagram illustrating a method of using the TeleShaper system to operate an existing software application in another language.

### DETAILED DESCRIPTION

Preferred embodiments of the invention will now be described with reference to the accompanying drawings.

### First Embodiment: Interface to an Existing Application via Wired and Wired Internets

In one aspect, the present invention is a system for and method of providing a remote interface to an existing computer application via wired and wireless Internets. The system is able to monitor and reinterpret the data streams present in existing applications and, according to rules established during a training sequence, reformat this data into updated forms, such as HTML, WML, or XML. This reformatted data can then be presented to the user via Internet-enabled devices. Further, when network-enabled, the system has the ability to access multiple data sources and present the contents of these data sources to the user with an updated interface.

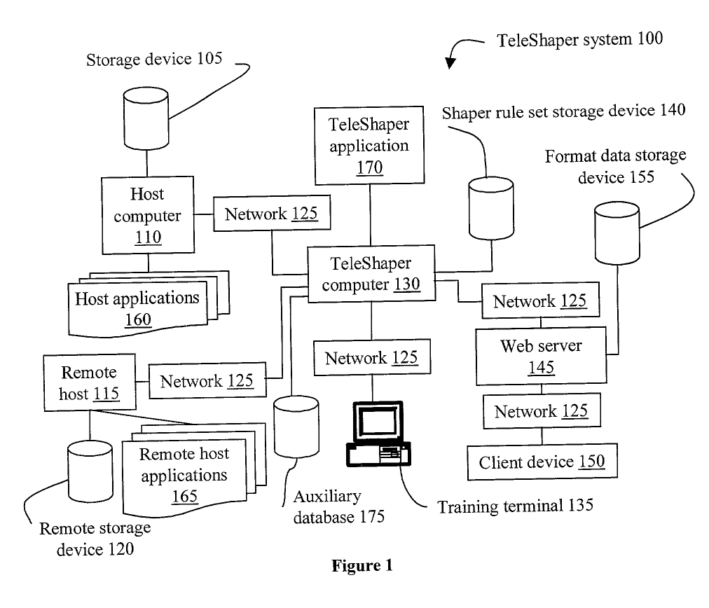

FIG. 1 is a schematic representation of a TeleShaper system 100. TeleShaper system 100 includes a TeleShaper computer 130, one or more host computers 110, one or more remote hosts 115, a Web server 145, a shaper rule set storage device 140, a format data storage device 155, one or more client devices 150, a training terminal 135, and an optional auxiliary database 175. Host computer 110 further includes a storage device 105 and host applications 160. Remote host 115 further includes a remote storage device 120 and remote host applications 165. TeleShaper computer 130 further includes TeleShaper application 170. TeleShaper system 100 also includes a network 125.

Host computer 110, remote host 115, Web server 145, and training terminal 135 may connect directly to TeleShaper computer 130 or via a network 125. Network 125 may be a wired or wireless intranet or the Internet. Client device 150 is defined as a client device that is, for example, a PC, cell phone, or PDA, upon which runs a browser application or any rendering program that converts a data stream to visual form. Client device 150 may connect directly to Web server 145 or via network 125.

Host applications 160 and remote host applications 165 may be one or more applications. Network 125 may be the same network or may be different networks.

In an alternate configuration from that shown in FIG. 1, multiple host computers 110 may connect directly to TeleShaper computer 130 or through network 125. Similarly, multiple remote hosts 115 may connect directly to TeleShaper computer 130 or through network 125.

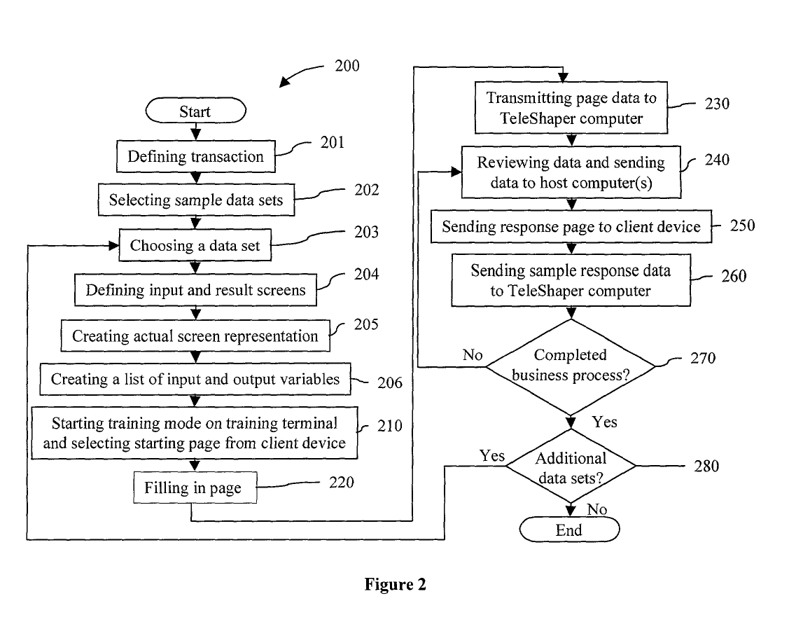

A method of defining the representation of data on the client device 150 and training TeleShaper system 100 to operate existing host applications 160 or remote host applications 165 is now described with reference to FIG. 2.

Step 201: Defining transaction

In this step, the user decides on the details of the transaction to be designed. This includes the client screens to be utilized, the data to be displayed on these screens, the data to be obtained from the user via these screens, and the host application operation associated with these data. Using training terminal 135, the user then enters into the TeleShaper rule set a list of the pages along with the name of each page's associated data items. In addition, the static portion of each page is entered onto format data storage device 155 and/or added to the rule set stored.

Step 202: Selecting sample data sets

In this step, the user selects and records a collection of sample input data to be used in subsequent steps. The data should include data sets that result in normal operation of the host application(s) as well as sets that cause the error conditions to be automatically corrected. The data sets may be stored on auxiliary database 175.

Step 203: Choosing a data set

In this step, the user selects one of the sample data steps defined in step 202 for use in operating the system.

Step 204: Defining input and result screens

In this step, the trainer defines a visual representation of input and result screens. The definition of the input and results screens is in accordance with the requirements of interfacing with host applications 160 or remote host applications 165. In this step, functionality may also be added or removed from host applications 160 or remote host applications 165. This step is performed on an abstract level using, for example, drawings, flowcharts, etc.

Step 205: Creating actual screen representation

In this step, the trainer, using training terminal 135, produces a computer representation of the input and result screens. For example, the trainer may define the HTML computer code using a standard HTML editor. In this step, the trainer creates a new “front end” for the host applications 160 or remote host applications 165, and may add or remove functionality from those applications.

Step 206: Creating a list of input and output variables

In this step, the trainer, using TeleShaper computer 130, creates one or more files that lists the input and output variables associated with each input and result screen. At this point, the client interface has been completely defined.

Step 210: Starting training mode on training terminal and selecting starting page from client device

In this step, the trainer, using training terminal 135, initiates the training mode and then requests the starting page of the newly defined interface using client device 150. This request is transmitted to Web server 145, which then returns the starting page to the client device 150.

Step 220: Filling in page

In this step, the trainer, using client device 150, fills in the requested information in the starting page.

Step 230: Transmitting page data to TeleShaper computer

In this step, the trainer, using client device 150, submits the starting page from client device 150. The data is transmitted to TeleShaper computer 130 via Web server 145. TeleShaper application 170 then transmits the page data to training terminal 135. The trainer at training terminal 135 is alerted to the fact this page data has been submitted. This begins the training session.

Step 240: Reviewing data and sending data to host computer(s)

In this step, the trainer, using training terminal 135, exercises host applications 160 or remote host applications 165. Using training terminal 135 and TeleShaper application 170, the trainer operates the host applications 160 or remote host applications 165 to obtain the needed responses to the form submitted in step 230. The sequence of steps for interacting with these host applications (known as the “rule set” ) is generated by TeleShaper application 170 and stored on shaper rule set storage device 140.

Step 250: Sending response page to client device

In this step, the trainer, using training terminal 135, instructs TeleShaper application 170 to send the data and page name to Web server 145. Web server 145 formats the data using the page selection according to format data stored on format data storage device 155, and transmits the data and page request to client device 150. Also in this step, additional elements of the “rule set” are generated by TeleShaper application 170 and stored on shaper rule set storage device 140.

Step 260: Sending sample response data to TeleShaper computer

In this step, the trainer, using client device 150, fills the form contained in the page sent in the previous step with sample data and submits the completed form to Web server 145. Web server 145 transmits the completed form to the TeleShaper application 170, which transmits the completed form to training terminal 135.

Step 270: Completed business process?

In this step, the trainer determines if system 100 is fully trained to accommodate the business processes of host applications 160 or remote host applications 165, where a “business process” is defined as a set of steps necessary to complete an objective, e.g., placing an order, checking status of shipment, filling out a questionnaire. If no, process 200 returns to step 240; if yes, process 200 proceeds to step 280.

Step 280: Additional data sets?

In this step, the trainer determines if there are additional data sets to process within TeleShaper system 100. If yes, process 200 returns to step 203; if no, process 200 ends.

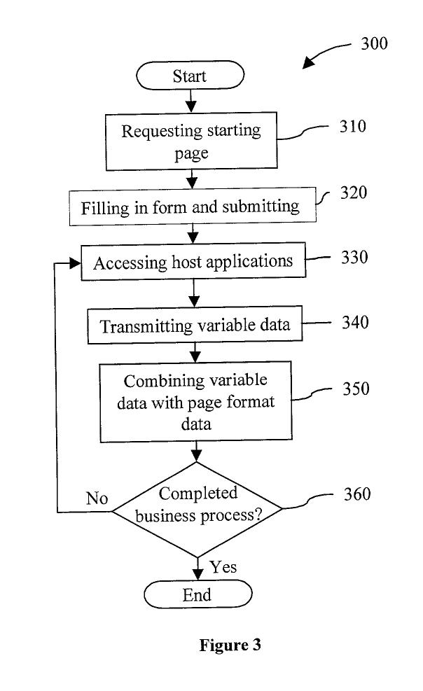

A method of using TeleShaper system 100 to operate an existing software application via the Internet is now described with reference to FIG. 3. Process 300 presumes that training process 200 has been completed and the results of process 200 have been stored on shaper rule set storage device 140.

Step 310: Requesting starting page

In this step, the user, using client device 150, requests the starting page of the transaction. This request is transmitted to Web server 145, which forwards the request to TeleShaper computer 130. TeleShaper computer 130 responds with the starting page name and variable data, which are combined with the format data for the selected page stored on the format data storage device 155 by the interface computer. The resulting page is then returned to the client device 150.

Step 320: Filling in form and submitting

In this step, the user, using client device 150, fills in the requested information in the starting form and submits the page to TeleShaper application 170 via Web server 145.

Step 330: Accessing host applications

In this step, in response to the form data, TeleShaper application 170 accesses the host applications 160 or remote host applications 165 using the rule set stored on shaper rule set storage device 140. In this way, TeleShaper application 170 operates the host application 160 or remote host application 165 to enter data, obtain data, and to respond to exceptions as instructed during the training sequence in process 200.

Step 340: Transmitting variable data

In this step, TeleShaper application 170 transmits the variable data obtained by interacting with host application 160 and/or remote host application 175 and/or auxiliary storage device 142 and/or calculated internally to Web server 145.

Step 350: Combining variable data with page format data

In this step, Web server 145 combines the variable data with the format data stored for the selected page on format data storage device 155 to produce a formatted page. This formatted page is transmitted to client device 150.

Step 360: Completed business process?

In this step, the user determines if there is additional data to process. If no, process 300 returns to step 330; if yes, process 300 ends.

### Second Embodiment: Providing a Voice Interface to an Existing Computer Program

In another embodiment, the present invention is a system for and method of providing a voice interface to an existing computer program. The system is able to monitor and reinterpret the data streams present in existing applications and, according to rules established during a training sequence, reformat this data into voice-enabled formats. This reformatted data can then be presented to the user via voice-enabled devices like cell phones. Further, when network-enabled, the system has the ability to access multiple data sources simultaneously.

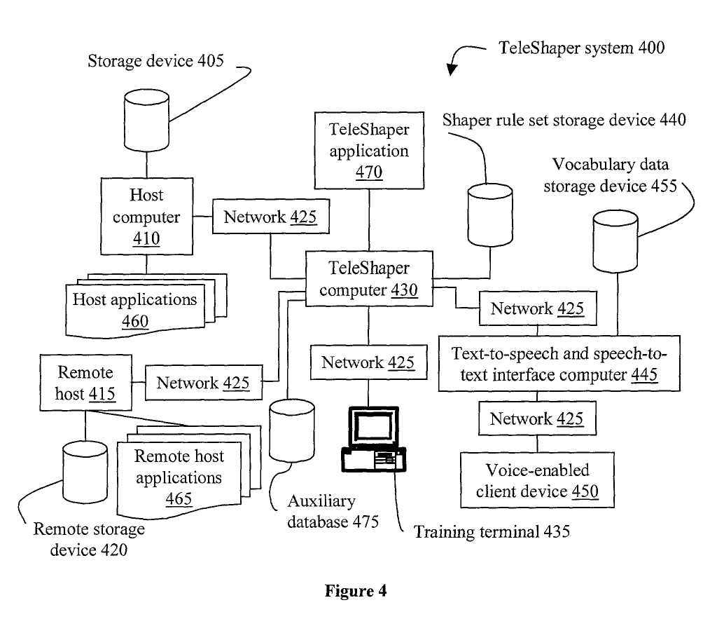

FIG. 4 is a schematic representation of a TeleShaper system 400. TeleShaper system 400 includes a TeleShaper computer 430, one or more host computers 410, optionally one or more remote hosts 415, a text-to-speech and speech-to-text interface computer 445, a shaper rule set storage device 440, a vocabulary data storage device 455, one or more voice-enabled client devices 450, a training terminal 435, and an optional auxiliary database 475. Host computer 410 further includes a storage device 405 and host applications 460. Remote host 415 further includes a remote storage device 420 and remote host applications 465. TeleShaper computer 430 further includes TeleShaper application 470. TeleShaper system 400 also includes a network 425.

Host computer 410, remote host 415, text-to-speech and speech-to-text interface computer 445, and training terminal 435 may connect directly to TeleShaper computer 430 or via a network 425. Network 425 may be an intranet or the Internet. Voice-enabled client device 450 is a device like a cell phone. Text-to-speech and speech-to-text interface computer 445 is defined as a computer upon which runs an application capable of converting a text data stream to audible form or an audio data stream to text form. Voice-enabled client device 450 may connect directly to text-to-speech and speech-to-text interface computer 445 or via network 425.

Vocabulary data storage device 455 contains a pre-defined and pre-recorded fixed portion of messages sent to voice-enabled client device 450. For example, in reporting a stock quote, the fixed portion of the message may be “The price of the requested stock is . . . ” The variable portion of the message is the actual stock price retrieved via host application 460 or remote host application 465.

Text-to-speech and speech-to-text interface computer 445 employs commercially available text-to-speech technology to convert text received from TeleShaper application 470. Text-to-speech and speech-to-text interface computer 445 combines the variable portion of the text from host applications 460 or remote host applications 465 with stored fixed prompts from vocabulary data storage device 455 and converts this text to speech data. This data is then transmitted to voice-enabled client device 450. Also, text-to-speech and speech-to-text interface computer 445 converts the user's speech to text using commercially available voice systems (e.g., Dragon NaturallySpeaking, Free Speech 5000, etc.). Text-to-speech and speech-to-text interface computer 445 transmits this converted text to TeleShaper application 470, which transmits it to host applications 460 or remote host applications 465 as an input. Alternatively, the user may input data through a keypad on voice-enabled client device 450. Text-to-speech and speech-to-text interface computer 445 is capable of processing this non-voice signal as an input.

Voice-enabled client device 450 is a device that digitizes voice signals, e.g., a digital cellular phone. Alternatively, the voice capability embodied in text-to-speech and speech-to-text interface computer 445 may reside on voice-enabled client device 450.

In an alternative configuration from that shown in FIG. 4, multiple host computers 410 may connect directly to TeleShaper computer 430 or through network 425. Similarly, multiple remote hosts 415 may connect directly to TeleShaper computer 430 or through network 425. Also, host applications 460 and remote host applications 465 may be one or more applications. Network 425 may be one network or may comprise multiple networks.

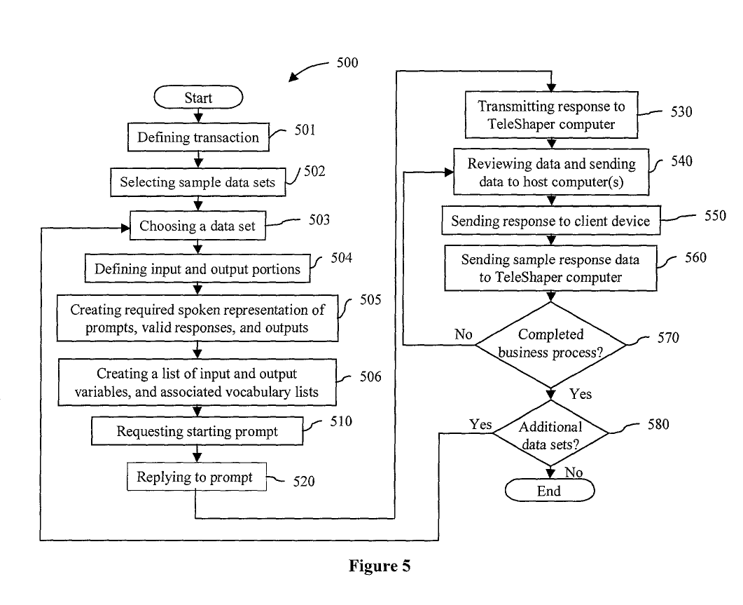

A method of defining the representation of data on the voice-enabled client device 450 and of training TeleShaper system 400 to operate existing host applications 460 or remote host applications 465 is now described with reference to FIG. 5.

Step 501: Defining transaction

In this step, the user decides on the details of the transaction to be defined. This includes breaking the transaction into a collection of “conversations” , e.g., voice prompts (possibly including host result data) and the possible replies to be obtained from the user via client device 450, and the host application operation associated with these data. Using training terminal 435, the user then enters into the TeleShaper “rule set” the list of these conversations along with the name of each conversation's associated data items. The rule set is defined as the sequence of steps necessary for interacting with the host applications. In addition, the static portion of each conversation's prompt is entered in vocabulary data storage device 455 and/or added to the rule set stored.

Step 502: Selecting sample data sets

In this step, the user selects and records a collection of sample input data sets to be used in subsequent steps. The data sets should include data sets that result in normal operation of the host application(s) as well as data sets that cause the error conditions to be automatically corrected. The data sets may be stored on auxiliary database 475.

Step 503: Choosing a data set

In this step, the user selects one of the sample data sets defined in step 502 for use in operating the system.

Step 504: Defining input and output portions

In this step, the trainer defines prompts for inputs and valid responses therefore, and fixed and variable portions of spoken outputs messages. The input and output messages are defined in accordance with the requirements of interfacing with host applications 460 or remote host applications 465. In this step, functionality may be added to or removed from host applications 460 or remote host applications 465. This step is performed on an abstract level using, for example, drawings, flowcharts, diagrams, etc.

Step 505: Creating required spoken representation of prompts, valid responses, and outputs

In this step, the trainer, using training terminal 435 and a speech recording apparatus, produces a spoken representation of the prompts, responses, and outputs. In this step, the trainer is creating a spoken “front end” for the host applications 460 or remote host applications 465 and, in doing so, may add or remove functionality from those applications.

Step 506: Creating a list of the input and output variables, and associated vocabulary lists

In this step, the trainer, using TeleShaper computer 430, creates one or more files that lists input and output variables associated with each conversation. In addition to defining the input and output variables communicated between TeleShaper application 430 and text-to-speech and speech-to-text interface computer 445, a limited input vocabulary is defined in this step to facilitate the voice recognition software. With the completion of this step, the client interface is fully defined.

Step 510: Requesting starting prompt

In this step, the trainer, using client device 450, requests, e.g., by text, by speech, or by dialing an access number, the starting prompt from text-to-speech and speech-to-text interface computer 445, which then speaks the starting prompt to client device 450.

Step 520: Replying to prompt

In this step, the trainer, using client device 450, speaks the requested information.

Step 530: Transmitting response to TeleShaper computer

In this step, text-to-speech and speech-to-text interface computer 445 converts the voice response from client device 450 to textual data. This data is then transmitted to TeleShaper computer 430. TeleShaper application 470 accumulates the response data and, as appropriate, transmits this data to training terminal 435. The trainer at training terminal 435 is alerted to the fact that this conversation data has been submitted. This begins the training session.

Step 540: Reviewing data and sending data to host computer(s)

In this step, the trainer, using training terminal 435, exercises host applications 460 or remote host applications 465. Using training terminal 435 and TeleShaper application 470, the trainer operates the host applications 460 or remote host applications 465 to obtain the needed responses to the data submitted in step 530. This rule set is generated by TeleShaper application 470 and stored on shaper rule set storage device 440.

Step 550: Sending response to client device

In this step, the trainer, using training terminal 435, instructs TeleShaper application 470 to send the data and the conversation's name to text-to-speech and speech-to-text interface computer 445. Text-to-speech and speech-to-text interface computer 445 combines the data with the fixed portion of the selected conversation's prompt according to vocabulary data stored on vocabulary data storage device 455 and speaks the result to voice-enabled client device 450. Also, in this step, additional elements of the “rule set” are generated by TeleShaper application 470 and stored on shaper rule set storage device 440.

Step 560: Sending sample response data to TeleShaper computer

In this step, the trainer, using voice-enabled client device 450, speaks the sample data and submits the data to text-to-speech and speech-to-text interface computer 445. Text-to-speech and speech-to-text interface computer 445 transmits the data to the TeleShaper application 470, which then transmits the data to training terminal 435.

Step 570: Completed business process?

In this step, the trainer determines if system 400 is fully trained to accommodate the business processes of host applications 460 or remote host applications 465, where a “business process” is defined as a set of steps necessary to complete an objective, e.g., placing an order, checking status of shipment, filling out a questionnaire. If no, process 500 returns to step 540; if yes, process 500 proceeds to step 580.

Step 580: Additional data sets?

In this step, the trainer determines if there are additional data sets to process within TeleShaper system 400. If yes, process 500 returns to step 503; if no, process 500 ends.

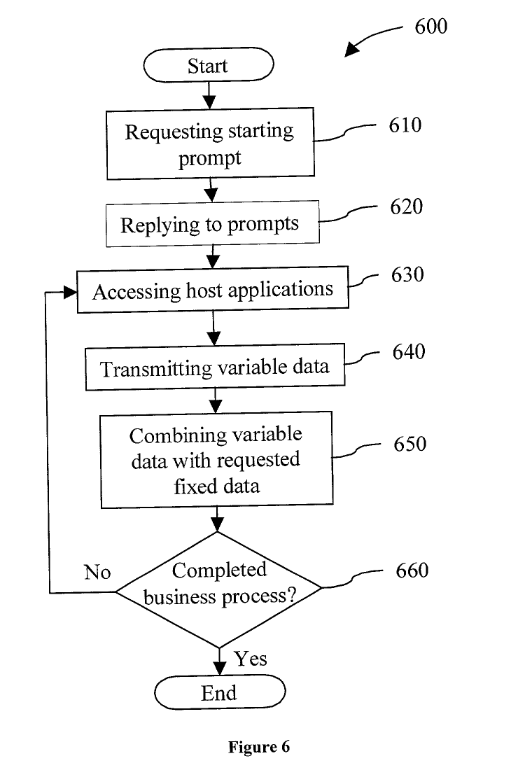

A method of using system 400 to insert data to and extract data from an existing software application via a voice interface is now described with reference to FIG. 6. Process 600 presumes that training process 500 has been completed and that the results of process 500 have been stored on shaper rule set storage device 440.

Step 610: Requesting starting prompt

In this step, the user, using client device 450, requests the starting prompt of the transaction. This request is transmitted to text-to-speech and speech-to-text interface computer 445, which forwards the request to TeleShaper computer 430. TeleShaper computer 430 responds with the starting conversation name and variable data, which are combined with the vocabulary data for the selected conversation stored on the vocabulary data storage device 455 by the text-to-speech and speech-to-text interface computer 445, converted to speech, and transmitted to the client device 450.

Step 620: Replying to prompts

In this step, the user, using voice-enabled client device 450, speaks the information requested by the starting prompt thereby submitting response data to TeleShaper application 470 via text-to-speech and speech-to-text interface computer 445.

Step 630: Accessing host applications

In this step, in response to the response data, TeleShaper application 470 accesses the host applications 460 or remote host applications 465 using the rule set stored on shaper rule set storage device 440. In this way, TeleShaper application 470 operates the host application 460 or remote host application 465 to enter data, obtain data, and to respond to exceptions as instructed during the training sequence in process 500.

Step 640: Transmitting variable data

In this step, TeleShaper application 470 transmits variable data to text-to-speech and speech-to-text interface computer 445. This variable data is obtained by the TeleShaper application 470 interacting with host application 460, remote host application 475, or auxiliary storage device 142.

Step 650: Combining variable data with requested fixed data

In this step, text-to-speech and speech-to-text interface computer 445 combines the variable data with the fixed data for the requested conversation stored on vocabulary data storage device 455 to produce a spoken message. This spoken message is transmitted to voice-enabled client device 450.

Step 660: Completed business process?

In this step, the user determines if there is additional data to process. If yes, process 600 returns to step 630; if no, process 600 ends.

### Third Embodiment: Providing an Interface to an Existing Computer Program in a Different Language

In yet another aspect, the present invention is a system for and method of providing an interface to an existing computer application in a different language. The system is able to monitor and reinterpret the data streams present in existing applications and, according to rules established during a training sequence, reformat this data into a different language and different format according to cultural conventions. When network-enabled, the system has the ability to access multiple data sources and present the contents of these data sources to the user with an updated interface.

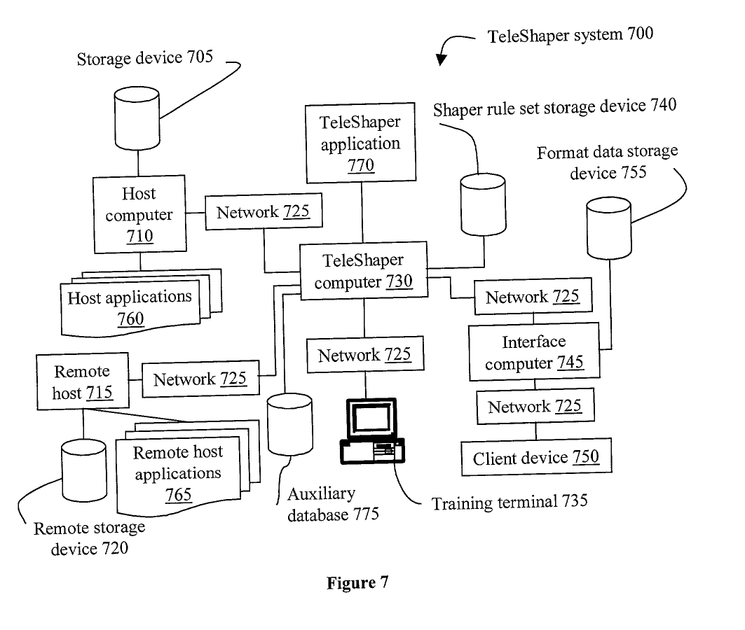

FIG. 7 is a schematic representation of a TeleShaper system 700. TeleShaper system 700 includes a TeleShaper computer 730, one or more host computers 710, optionally one or more remote hosts 715, an interface computer 745, a shaper rule set storage device 740, a format data storage device 755, one or more client devices 750, a training terminal 735, and an optional auxiliary database 775. Host computer 710 further includes a storage device 705 and host applications 760. Remote host 715 further includes a remote storage device 720 and remote host applications 765. TeleShaper computer 730 further includes TeleShaper application 770. TeleShaper system 700 also includes a network 725.

Host computer 710, remote host 715, interface computer 745, and training terminal 735 may connect directly to TeleShaper computer 730 or via a network 725. Network 725 may be an intranet or the Internet. Client device 750 may connect directly to interface computer 745 or via network 725.

Host applications 760 and remote host applications 765 may be one or more applications. Network 725 may be the same network or may be multiple networks.

In an alternate configuration from that shown in FIG. 7, multiple host computers 710 may connect directly to TeleShaper computer 730 or through network 725. Similarly, multiple remote hosts 715 may connect directly to TeleShaper computer 730 or through network 725.

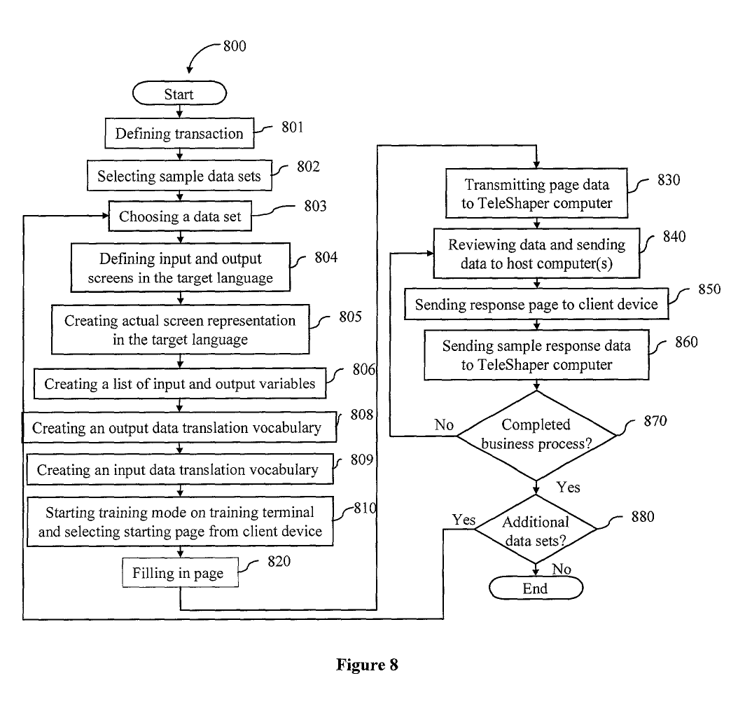

A method of defining the representation of data on the client device 750 and of training TeleShaper system 700 to operate existing host applications 760 or remote host applications 765 in another language is now described with reference to FIG. 8.

Step 801: Defining transaction

In this step, the user decides on the details of the transaction to be defined. This includes the client screens to be utilized, the data to be displayed on these screens, the data to be obtained from the user via these screens, and the host application operation associated with these data. Using training terminal 735, the user then enters into the TeleShaper “rule set” a list of pages along with the name of each page's associated data items. The rule set is defined as the sequence of steps necessary for interacting with the host applications. In addition, the static portion of each page is stored in format data storage device 755 and/or added to the rule set.

Step 802: Selecting sample data sets

In this step, the user selects and records a collection of sample input data sets in both the source and target languages to be used in subsequent steps. The data sets should include data sets that result in normal operation of the host application(s) as well as data sets that cause the error conditions that are to be automatically corrected. The data sets may be stored on auxiliary database 775.

Step 803: Choosing a data set

In this step, the user selects one of the sample data sets defined in step 802 for use in operating the system.

Step 804: Defining input and output screens in the target language

In this step, the trainer defines a visual representation of input and output screens in the target language. The definition of the input and output screens is in accordance with the requirements of interfacing with host applications 760 or remote host applications 765. In this step, functionality may also be added to or removed from host applications 760 or remote host applications 765. This step is performed on an abstract level using, for example, drawings, flowcharts, etc.

Step 805: Creating actual screen representation in the target language

In this step, the trainer, using training terminal 735, produces a computer representation of the input and output screens in the target language. In this step, the trainer creates a new “front end” for the host applications 760 or remote host applications 765, and may add or remove functionality from those applications.

Step 806: Creating a list of input and output variables

In this step, the trainer, using TeleShaper computer 730, creates one or more files that list the input and output variables associated with each input and output screen. At this point, the client interface has been completely defined.

Step 808: Creating an output data translation vocabulary

In this step, the trainer, using TeleShaper computer 730, creates a translation vocabulary for the source language into the target language for the output data.

Step 809: Creating an input data translation vocabulary

In this step, the trainer, using TeleShaper computer 730, creates a translation vocabulary for the target language into the source language for the input data.

Step 810: Starting training mode on training terminal and selecting starting page from client device

In this step, the trainer, using training terminal 735, initiates the training mode and requests the starting page of the newly defined interface from client device 750. This request is transmitted to interface computer 745, which then returns the starting page to the client device 750.

Step 820: Filling in page

In this step, the trainer, using client device 750, fills in the requested information in the starting page.

Step 830: Transmitting page data to TeleShaper computer

In this step, the trainer, using client device 750, submits the starting page from client device 750. The data is transmitted to TeleShaper computer 730 via interface computer 745. TeleShaper application 770 then transmits the page data to training terminal 735. The trainer at training terminal 735 is alerted to the fact that this page data has been submitted. This begins the training session.

Step 840: Reviewing data and sending data to host computer(s)

In this step, the trainer, using training terminal 735, exercises host applications 760 or remote host applications 765. Using training terminal 735 and TeleShaper application 770, the trainer operates the host applications 760 or remote host applications 765 to obtain the needed responses to the form submitted in step 230. This rule set is generated by TeleShaper application 770 and stored on shaper rule set storage device 740.

Step 850: Sending response page to client device

In this step, the trainer, using training terminal 735, instructs TeleShaper application 770 to send the data and the response page selection to interface computer 745. Interface computer 745 formats the data and according to the page selection based on the format data stored on format data storage device 755, and transmits the data and page request to client device 750. Also in this step, additional elements of the “rule set” are generated by TeleShaper application 770 and stored on shaper rule set storage device 740.

Step 860: Sending sample response data to TeleShaper computer

In this step, the trainer, using client device 750, fills the test form with sample data and submits the completed form to interface computer 745. Interface computer 745 transmits the completed form to the TeleShaper application 770, which then transmits the completed form to training terminal 735.

Step 870: Completed business process?

In this step, the trainer determines if system 700 is fully trained to accommodate the business processes of host applications 760 or remote host applications 765, where a “business process” is defined as a set of steps necessary to complete an objective, e.g., placing an order, checking status of shipment, filling out a questionnaire. If no, process 800 returns to step 840; if yes, process 800 proceeds to step 880.

Step 880: Additional data sets?

In this step, the trainer determines if there are additional data sets to process within TeleShaper system 700. If yes, process 800 returns to step 803; if no, process 800 ends.

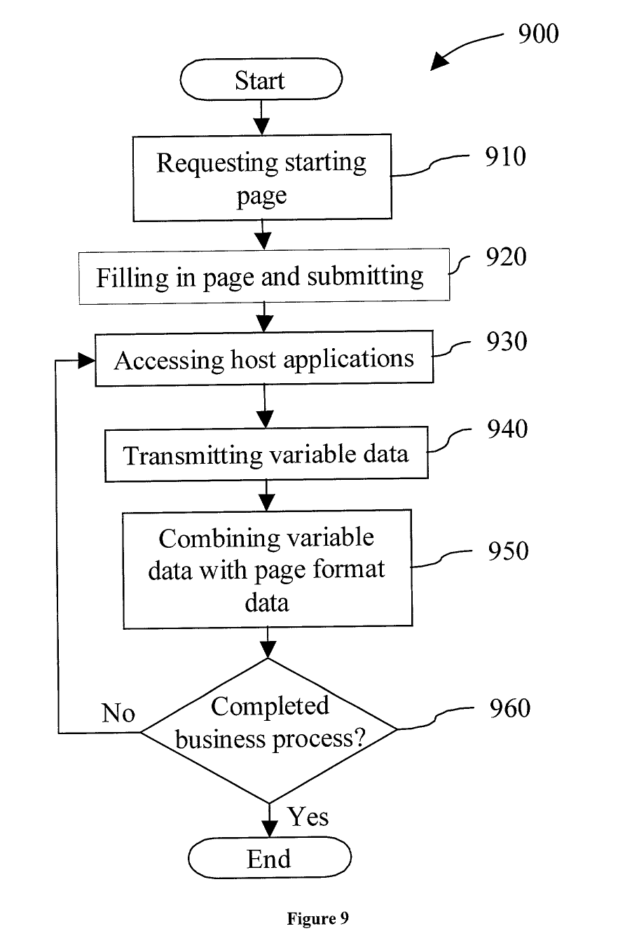

A method of using TeleShaper system 700 to operate an existing software application in another language is now described with reference to FIG. 9. Process 900 presumes that training process 800 has been completed and that the results of process 800 have been stored on shaper rule set storage device 740.

Step 910: Requesting starting page

In this step, the user, using client device 750, requests the starting page of the transaction in the target language. This request is transmitted to interface computer 745, which translates the data to the source language and forwards the request to TeleShaper computer 730. TeleShaper computer 730 responds with the starting page name and variable data, which are combined with the format data for the selected page stored on the format data storage device 755 by the interface computer. The resulting page is then returned to the client device 750 in the target language.

Step 920: Filling in page and submitting

In this step, the user, using client device 750 and working in the target language, fills in the requested information in the starting page and submits the page to TeleShaper application 770 via interface computer 745.

Step 930: Accessing host applications

In this step, in response to the form data, TeleShaper application 770 accesses the host applications 760 or remote host applications 765 in the source language using the rule set stored on shaper rule set storage device 740. In this way, TeleShaper application 770 operates the host application 760 or remote host application 765 to enter data, obtain data, and to respond to exceptions as instructed during the training sequence in process 800.

Step 940: Transmitting variable data

In this step, TeleShaper application 770 transmits variable data to interface computer 745. This variable data is obtained by the TeleShaper application 770 interacting with host application 760, remote host application 775, or auxiliary storage device 705.

Step 950: Combining variable data with page format data

In this step, interface computer 745 combines the variable data with the page format data stored on format data storage device 755 to produce a page formatted to cultural conventions. This formatted page is transmitted to client device 750 in the target language.

Step 960: Completed business process?

In this step, the user determines if there is additional data to process. If yes, process 900 returns to step 930; if no, process 900 ends.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A trainable system for providing an interface to an existing software application via a wired or wireless network, comprising:
a first computer operating a trainable user interface translator application and adapted to store a shaper rule set;
a Web server electrically connected to the first computer, one or more client devices, and a format data storage device;
a training terminal electrically connected to the first computer for establishing the shaper rule set during a training session;
one or more host computers electrically connected to the first computer and operating one or more existing host applications, thereby generating data streams which may be monitored by the first computer;
a network providing electrical connection between the first computer and the web server, the first computer and the training terminal, the first computer and the one or more host computers, and the web server and one or more client devices;
wherein the first computer transmits data received from the one or more client devices via the web server to the one or more host computers and, according to the shaper rule set established during the training session, monitors and reinterprets the data streams present in the existing host applications into updated forms for transmission to the web server, which reformats the updated forms using format data stored in the format data storage device for transmission to the one or more client devices.

2. The trainable system of claim 1, wherein the network is a wired or wireless intranet.

3. The trainable system of claim 1, wherein the network is the Internet.

4. The trainable system of claim 1, further comprising an auxiliary database electrically connected to the first computer for storage and retrieval of training data sets to be employed during the training session.

5. The trainable system of claim 1, wherein at least one of the one or more host computers comprises a remote host computer further including a remote storage device and operating at least one remote host application.

6. The trainable system of claim 1, wherein the one or more client devices is a device upon which operates a browser application.

7. The trainable system of claim 1, wherein the one or more client devices is a device upon which operates any rendering application that converts a data stream into visual form.

8. The trainable system of claim 1, further comprising a rule set storage device electrically connected to the first computer for storing the shaper rule set.

9. In a trainable system comprising a first computer operating a trainable user interface translator application and adapted to store a rule set, a web server electrically connected to the first computer and a client device, one or more host computers electrically connected to the first computer and operating one or more host applications, and a training terminal electrically connected to the first computer, a method of defining the representation of data on the client device and training the trainable system to operate the one or more host applications to insert data to and extract data from one or more host computers comprising the steps of:
defining a transaction from the training terminal;
selecting sample training data sets;
choosing a data set from the training data sets;
defining input and result screens;
creating an actual screen representation in accordance with the requirements of the one or more host applications using the training terminal;
creating a list of input and output variables;
starting training mode on the training terminal and selecting a starting page from a client device;
filling in page data from the client device;
transmitting the page data to the first computer from the client device via the web server;
exercising the one or more host applications from the training terminal to obtain needed responses to the page data, while storing the sequence of steps for exercising the one or more host applications as a rule set;
instructing the first computer from the training terminal to send a response page to the client device via the web server, while storing additional elements in the rule set;
completing a form contained in the response page at the client device and sending the completed form to the training terminal via the first computer;
determining if the trainable system is fully trained to complete a business process, and if not, reverting to the step of exercising the one or more host applications; and
determining if there are additional selected sample training data sets to process, and if so, reverting to the choosing a data set step.

10. The method of claim 9, wherein the electrical connections are provided by a wired network.

11. The method of claim 9, wherein the electrical connections are provided by a wireless network.

12. The method of claim 9, wherein at least one of the one or more host computers comprises a remote host computer operating at least one remote host application.

13. The method of claim 9, wherein the client device is a device upon which operates a browser application.

14. The method of claim 9, wherein the client device is a device upon which operates any rendering application that converts a data stream into visual form.

15. The method of claim 9, wherein the sample training data sets are stored in and retrieved from an auxiliary database.

16. The method of claim 9, wherein the web server formats the response page by combining format data stored on a format data storage device with page name and variable data received from the first computer.

17. In a trained system comprising a first computer storing a rule set, a web server electrically connected to the first computer and a client device, a host computer electrically connected to the first computer and operating one or more existing host applications, wherein wired and wireless networks provide the electrical connections, a method of using the first computer to operate the one or more existing host applications via wired and wireless networks comprising the steps of:
requesting at the client device a starting form from the first computer via the web server;
filling in at the client device form data into a form returned from the first computer and submitting the form data to the first computer;
accessing the one or more host applications by the first computer in accordance with the stored rule set, thereby entering data, obtaining data, and responding to exceptions in a manner predetermined during a training session;
transmitting to the web server variable data obtained by interacting with the one or more host applications;
combining the variable data with page format data to produce a formatted page; and
determining if the business process is complete, and if not, reverting to the accessing step.

18. The method of claim 17, wherein the variable data is further obtained by interacting with an auxiliary storage device.

19. The method of claim 17, wherein the variable data is further obtained by internal calculation.

20. The method of claim 17, wherein the host computer is a remote host computer operating one or more remote host applications.

21. A trainable system for providing a voice interface to an existing software application, comprising:
a first computer operating a trainable user interface translator application and adapted to store a shaper rule set;
a text-to-speech and speech-to-text interface computer electrically connected to the first computer, one or more voice-enabled client devices, and a vocabulary data storage device;
a training terminal electrically connected to the first computer for establishing the shaper rule set during a training session; one or more host computers electrically connected to the first computer and operating one or more existing host applications, thereby generating data streams which may be monitored by the first computer;
wherein the first computer transmits data received from the one or more voice-enabled client devices via the text-to-speech and speech-to-text interface computer to the one or more host computers and, according to the shaper rule set established during the training session, monitors and reinterprets the data streams present in the existing host applications into updated forms for transmission to the text-to-speech and speech-to-text interface computer, which reformats the updated forms using vocabulary data stored in the vocabulary data storage device for transmission to the one or more voice-enabled client devices.

22. The trainable system of claim 21, wherein a network provides the electrical connections between the first computer and the text-to-speech and speech-to-text interface computer, the first computer and the training terminal, the first computer and the one or more host computers, and the text-to-speech and speech-to-text interface computer and one or more voice-enabled client devices.

23. The trainable system of claim 21, further comprising an auxiliary database electrically connected to the first computer for storage and retrieval of training data sets to be employed during the training session.

24. The trainable system of claim 21, wherein at least one of the one or more host computers comprises a remote host computer further including a remote storage device and operating at least one remote host application.

25. The trainable system of claim 21, further comprising a rule set storage device electrically connected to the first computer for storing the shaper rule set.

26. In a trainable system comprising a first computer operating a trainable user interface translator application and adapted to store a rule set, a text-to-speech and speech-to-text interface computer electrically connected to the first computer and a voice-enabled client device, one or more host computers electrically connected to the first computer and operating one or more host applications, and a training terminal electrically connected to the first computer, a method of defining the representation of data on the voice-enabled client device and training the trainable system to operate the one or more host applications to insert data to and extract data from one or more host computers comprising the steps of:
defining a transaction via the training terminal;
selecting sample training data sets;
choosing a data set from the training data sets;
defining input and output portions;
creating a required spoken representation of prompts, valid responses, and outputs in accordance with the requirements of the one or more host applications via the training terminal;
creating a list of input and output variables, and associated vocabulary lists; requesting a starting prompt from a voice-enabled client device;
replying to the prompt via the voice-enabled client device;
transmitting the reply to the first computer from the voice-enabled client device via the text-to-speech and speech-to-text interface computer;
exercising the one or more host applications from the training terminal to obtain needed responses to the reply transmitted, while storing the sequence of steps for exercising the one or more host applications as a rule set;
instructing the first computer via the training terminal to send a response to the voice-enabled client device via the text-to-speech and speech-to-text interface computer, while storing additional elements in the rule set;
speaking the sample data via the voice-enabled client device and sending the voice data to the training terminal via the first computer;
determining if the trainable system is fully trained to complete a business process, and if not, reverting to the step of exercising the one or more host applications; and
determining if there are additional selected sample training data sets to process, and if so, reverting to the choosing a data set step.

27. The method of claim 26, wherein the electrical connections are provided by a wired network.

28. The method of claim 26, wherein the electrical connections are provided by a wireless network.

29. The method of claim 26, wherein at least one of the one or more host computers comprises a remote host computer operating at least one remote host application.

30. The method of claim 26, wherein the sample training data sets are stored and retrieved from an auxiliary database.

31. The method of claim 26, wherein the text-to-speech and speech-to-text interface computer formats the response by combining vocabulary data stored on a vocabulary data storage device with prompt and variable data received from the first computer.

32. In a trained system comprising a first computer storing a rule set, a text-to-speech and speech-to-text interface computer electrically connected to the first computer and a voice-enabled client device, a host computer electrically connected to the first computer and operating one or more existing host applications, a method of using the first computer to interface an existing software application with a voice-enabled client device comprising the steps of:
requesting via the voice-enabled client device a starting prompt from the first computer via the text-to-speech and speech-to-text interface computer;
replying via the voice-enabled client device to the prompt returned from the first computer and submitting the reply data to the first computer;
accessing the one or more host applications by the first computer in accordance with the stored rule set, thereby entering data, obtaining data, and responding to exceptions in a manner predetermined during a training session;
transmitting variable data to the text-to-speech and speech-to-text interface computer obtained by interacting with the one or more host applications;
combining the variable data with vocabulary data to produce a spoken message; and
determining if the business process is complete, and if not, reverting to the accessing step.

33. The method of claim 32, wherein the variable data is further obtained by interacting with an auxiliary storage device.

34. The method of claim 32, wherein the variable data is further obtained by internal calculation.

35. The method of claim 32, wherein the host computer is a remote host computer operating one or more remote host applications.

36. A trainable system for providing an interface to an existing software application in a different language, comprising:
a first computer operating a trainable user interface translator application and adapted to store a shaper rule set;
an interface computer electrically connected to the first computer, one or more client devices, and a format data storage device;
a training terminal electrically connected to the first computer for establishing the shaper rule set during a training session;
one or more host computers electrically connected to the first computer and operating one or more existing host applications, thereby generating data streams which may be monitored by the first computer;
wherein the first computer transmits data received from the one or more client devices via the interface computer to the one or more host computers and, according to the shaper rule set established during the training session, monitors and reinterprets the data streams present in the existing host applications into updated forms for transmission to the interface computer, which reformats the updated forms using target language data stored in the format data storage device for transmission to the one or more client devices.

37. The trainable system of claim 36, wherein a network provides the electrical connections between the first computer and the interface computer, the first computer and the training terminal, the first computer and the one or more host computers, and the interface computer and one or more client devices.

38. The trainable system of claim 36, further comprising an auxiliary database electrically connected to the first computer for storing training data sets to be employed during the training session.

39. The trainable system of claim 36, wherein at least one of the one or more host computers comprises a remote host computer further including a remote storage device and operating at least one remote host application.

40. The trainable system of claim 36, further comprising a rule set storage device electrically connected to the first computer for storing the shaper rule set.

41. In a trainable system comprising a first computer operating a trainable user interface translator application and adapted to store a rule set, an interface computer electrically connected to the first computer and a client device, one or more host computers electrically connected to the first computer and operating one or more host applications, and a training terminal electrically connected to the first computer, a method of defining the representation of data on the client device and training the trainable system to operate the one or more host applications to insert data to and extract data from one or more host computers in another language, comprising the steps of:
defining a transaction via the training terminal and storing data elements of the transaction in a rule set;
selecting sample training data sets in a source language and a target language; choosing a data set from the training data sets;
defining input and output screens in accordance with interface requirements of the one or more host applications;
creating a representation of input and output screens in the target language via the training terminal;
creating a list of input and output variables associated with each input and output screen;
creating an output data translation vocabulary;
creating an input data translation vocabulary;
initiating training via the training terminal and requesting a starting page from the client device;
completing with page data a form returned from the interface computer in response to the request for the starting page;
transmitting the page data to the first computer via the interface computer;
exercising the one or more host applications via the training terminal to obtain needed responses to the page data submitted, while storing the sequence of steps for exercising the one or more host applications in the rule set;
instructing the first computer to send the page data and a response page to the interface computer for formatting in accordance with format data stored on the format data storage device and forwarding to the client device, while storing additional elements in the rule set;
replying via the client device with sample data to the training terminal via the interface computer and first computer;
determining if the trainable system is fully trained to complete a business process, and if not, reverting to the step of exercising the one or more host applications; and
determining if there are additional selected sample training data sets to process, and if so, reverting to the choosing a data set step.

42. The method of claim 41, wherein the electrical connections are provided by a wired network.

43. The method of claim 41, wherein the electrical connections are provided by a wireless network.

44. The method of claim 41, wherein at least one of the one or more host computers comprises a remote host computer operating at least one remote host application.

45. The method of claim 41, wherein the sample training data sets are stored in and retrieved from an auxiliary database.

46. In a trained system comprising a first computer storing a rule set, an interface computer electrically connected to the first computer and a client device, a host computer electrically connected to the first computer and operating one or more existing host applications, a method of using the first computer to operate an existing software application in another language comprising the steps of:
requesting, using the client device, a starting page of a transaction in a target language from the first computer via the interface computer which translates the target language to a source language;
filling in, at the client device, page data into a page returned from the first computer and submitting the page data to the first computer;
accessing the one or more host applications in the source language in accordance with the stored rule set, thereby entering data, obtaining data, and responding to exceptions in a manner predetermined during a training session;
transmitting to the interface computer variable data obtained by interacting with the one or more host applications;
combining the variable data with page format data to produce a page formatted to cultural conventions, and transmitting the formatted page to the client device in the target language; and
determining if the business process is complete, and if not, reverting to the accessing step.

47. The method of claim 46, wherein the variable data is further obtained by interacting with an auxiliary storage device.

48. The method of claim 46, wherein at least one of the one or more host computers is a remote host computer operating one or more remote host applications.
